(19) United States
(12) Patent Application Publication
(10) Pub. No.: US 2011/0316877 A1
(43) Pub. Date: Dec. 29, 2011

(54) DISPLAY AREA CONTROL APPARATUS, DISPLAY AREA CONTROL METHOD, AND INTEGRATED CIRCUIT

(76) Inventor: Hidehiko Shin, Osaka (JP)

(21) Appl. No.: 13/254,031

(22) PCT Filed: Dec. 7, 2010
(86) PCT No.: PCT/JP2010/007108

§ 371 Date: Aug. 31, 2011

(30) Foreign Application Priority Data
Jan. 8, 2010 (JP) 2010-003325

(51) Int. Cl. G09G 5/00

(52) U.S. Cl. 345/620

(57) ABSTRACT

The present invention provides a display area control apparatus which makes a user feel less uncomfortable when displaying a screen component takes much time. A display area control apparatus (100) includes: a display unit (109); a data storage unit (107) storing data for displaying screen components; a screen component reflecting unit (105) obtaining the data stored in the data storage unit (107), and reflecting the obtained data on the screen components; a screen component state storage unit (106) storing a reflection state; a display area control unit (108) determining a display area based on the reflection state; and a screen component managing unit (104) displaying, on the display area, the screen components having the data reflected, and to hide screen components, with reflection of the data incomplete, which are included in the screen components.

### TECHNICAL FIELD

The present invention relates to display area control apparatuses, display area control methods, and integrated circuits for displaying a screen component which is a display element.

### BACKGROUND ART

Personal computers (PCs) have become common and home appliances have turned into digital, and the amount and types of data for a user to handle, including images, moving images, and text, are rapidly increasing. In order to search for data of the user's desire through a large amount of data stored in a PC or a digital appliance, the user needs an operation screen to display a list of the data.

When there is much data, the appliance cannot display all the data on the operation screen. In the case where the operation screen cannot display all the data at once, the user can see undisplayed data by scrolling the list or switching information to be displayed on the list. Here, the user scrolls the list to sequentially see the data on the operation screen. This operation is beneficial in improving the listing capability of the operation screen.

In addition to the improved listing capability, operation screens included in recent PCs and digital appliances appear graphical. One of the graphical operation screens is CoverFlow stored in the Apple iPhone (trademark), and used for displaying a data list. CoverFlow is an operation screen for displaying a data list through smooth scrolling, using visual effects fully taking advantage of animation.

Furthermore, a similar advantage is provided to an operation screen for displaying an address list stored in the iPhone. Such operation screens make it possible for the user to have new experience of pleasantly browsing and looking for data.

On the operation screen, data is represented in a screen component showing a character, an image or a moving image, or a screen component showing a combination of the character, the image, and the moving image.

Meanwhile, recent displays have become larger. The full HD (1920×1080) has become the mainstream resolution of a display. In the years ahead, the resolution referred to as 4k2k (3840×2160) is expected to replace the full HD. The larger displays tend to increase the amount of data to be displayed on an operation screen at once.

When all of screen components for as much data as found are created in the case where the data to be displayed on the operation screen is large in amount, problems develop in that creating all the screen components takes so much time and memory amount. A typical solution to the problems is to create only a screen component necessary for displaying the operation screen. Then, an undisplayed screen component is created on a need-to-create basis. This operation allows the appliance to reduce the time required for displaying a screen component, and decrease the memory amount to be used.

In the case of an appliance including a display with low resolution (480×320), such as the iPhone, there are not many screen components to be displayed. Thus, the above solution is effective. Compared with the display area of the iPhone, however, the display area of a 4k2k display is 54 times larger than that of the iPhone. In other words, the 4k2k display provides more screen components to be displayed on the operation screen. This results in an increase in processing amount for displaying the entire operation screen.

The higher display resolution becomes, the greater the display size of each screen component will be. As a result, it will take more time to displaying the screen component. As the displays have become larger, simply applying the above solution leaves some screen components undisplayed when the user quickly scrolls the operation screen. Moreover, when data on the Internet is to be displayed, downloading the data takes so much time that some screen components are left undisplayed when the user quickly scrolls the operation screen.

When there is a screen component which is undisplayed, the appliance, for example, displays an operation screen after the scrolling once the screen component is created; that is, once the screen component is ready to be displayed. In this case, however, displaying the operation screen after scrolling takes much time. Thus, the user feels irritated in operating the appliance.

Then, the appliance displays the operation screen after scrolling with an uncreated screen component left undisplayed. In other words, the operation screen after scrolling is displayed with a blank space. Alternatively, the appliance displays surrogate data in a part where the screen component is supposed to be displayed. Then, after the screen component is created, the appliance displays the screen component. Through this operation, the appliance makes the user feel less irritated. One of the conventional techniques described above is the one disclosed in Patent Literature 1 is known, for example.

### [Citation List]

### [Patent Literature]

### [PTL 1] Japanese Unexamined Patent Application Publication No. 2002-290718

### SUMMARY OF INVENTION

### [Technical Problem]

The blank part of the operation screen makes the operation screen appear strange and unnatural.

Thus, as described above, the appliance sometimes displays surrogate data instead of a screen component. Here, the surrogate data should be prepared in advance. In addition, the surrogate data differs from a screen component other than the surrogate data in display format. Hence, even the use of the surrogate data makes the operation screen appear strange and unnatural. Furthermore, there is a case where displaying the surrogate data takes much time. Here, similar to the case where the surrogate data is not used, a part of the operation screen goes blank. Thus, the operation screen appears strange and unnatural.

In particular, when a large amount of data is displayed on the screen or when the user quickly scrolls the operation screen, the appliance cannot display the screen component in time. This makes the operation screen appear even stranger.

The present invention is conceived in view of the above problems and has an object to provide a display area control apparatus which makes a user feel less uncomfortable when displaying a screen component takes much time.

### [Solution to Problem]

In order to solve the above problems, a display area control apparatus according to an aspect of the present invention displays one or more screen components that are display elements, and includes: a display unit; a data storage unit which stores data for displaying the screen components; a screen component reflecting unit which obtains the data stored in the data storage unit, and to reflect the obtained data on the screen components; a screen component state storage unit which stores a reflection state indicating whether or not the data is reflected on each of the screen components; a display area control unit which determines, based on the reflection state, a display area for displaying, on the display unit, one or more screen components included in the screen components and having the data reflected; and a screen component managing unit which displays, on the display area, the screen components having the data reflected, and to hide one or more screen components with reflection of the data incomplete.

This structure makes it possible to hide an undisplayable screen component which takes too much time for the data reflection. Thus, the display area control apparatus 100 can make the user feel less uncomfortable when a screen component takes so much time to be displayed.

The display area control unit may determine the display area such that the screen components with the reflection of the data incomplete are excluded from the display area.

This operation makes it possible to change the display area according to a displayable screen component. Accordingly, no blank part appears on the display. Thus, the display area control apparatus can make the user feel less uncomfortable.

The screen component managing unit may hide the screen components with the reflection of the data incomplete by enlarging a size of the screen components having the data reflected.

This operation makes it possible to exclude to hide an undisplayable screen component. Thus, the display area control apparatus can make the user feel less uncomfortable without changing the display area.

The screen component managing unit may hide the screen components with the reflection of the data incomplete by providing a greater space between the screen components having the data reflected.

This operation makes it possible to exclude to hide an undisplayable screen component. Thus, the display area control apparatus can make the user feel less uncomfortable, keeping the sizes of the display area and a screen component.

The screen component managing unit may hide the screen components with the reflection of the data incomplete by providing a gradation on the screen components with the reflection of the data incomplete.

This operation allows an undisplayable screen component to be naturally hidden by the gradation.

The display area control apparatus may further include: a request receiving unit which receives a scroll request for sequentially displaying the screen components; and an operation screen creating unit which determines one or more screen components to be displayed according to the scroll request, the one or more screen components to be displayed being included in the screen components, wherein the display area control unit may determine the display area according to a reflection state of the screen components to be displayed determined by the operation screen creating unit, and among the screen components to be displayed determined by the operation screen creating unit, the screen component managing unit may (i) display, on the display area, the screen components having the data reflected, and (ii) hide the screen components with the reflection of the data incomplete.

This operation makes it possible to hide a screen component which cannot be displayed along with the scrolling. Accordingly, the user feels less uncomfortable.

When determining the screen components to be displayed according to the scroll request, the operation screen creating unit may determine the screen components to be displayed with reference to the reflection state such that a value indicating the number of the screen components with the reflection of the data incomplete is within a predetermined range.

Thus, when there are more screen components to be hidden, this operation changes the scrolling amount and the scrolling speed. Thus, the display area control apparatus can reduce the amount of the screen components to be hidden and make the user feel less uncomfortable.

The screen component state storage unit may further store a standby state indicating whether or not a screen component included in the screen components is a standby screen component on which the data is to be reflected for display preparation. The display area control unit may determine the display area according to the standby state such that the standby screen component is excluded from the display area. The screen component managing unit may (i) display, on the display area, a screen component (a) included in the screen components, (b) not being the standby screen component, and (c) having the data reflected, and (ii) hide the screen component with the reflection of the data incomplete and the standby screen component.

This operation allows data to be reflected on a screen component before the screen component is designated to be displayed. Thus, the display area control apparatus can handle high-speed display switching, such as the scrolling.

A method for controlling a display area control apparatus according to another aspect of the present invention is used for displaying one or more screen components that are display elements. The method includes: obtaining data stored in a data storage unit, and reflecting the obtained data on the screen components, the data storage unit storing the data for displaying the screen components; determining a display area for displaying, on a display unit, one or more screen components included in the screen components and having the data reflected, based on a reflection state stored in a screen component state storage unit, the reflection state indicating whether or not the data is reflected on each of the screen components; and displaying on the display area the screen components having the data reflected, and to hide one or more screen components with reflection of the data incomplete.

This operation makes it possible to hide an undisplayable screen component which takes too much time for the data reflection. Accordingly, the user feels less uncomfortable when displaying a screen component takes too much time.

An integrated circuit according to another aspect of the present invention is used for displaying one or more screen components that are display elements. The integrated circuit includes: a screen component reflecting unit which obtains data stored in a data storage unit, and reflects the obtained data on the screen components, the data storage unit storing the data to be used for displaying the screen components; a display area control unit which determines a display area for displaying, on a display unit, one or more screen components included in the screen components and having the data reflected, based on a reflection state stored in a screen component state storage unit, the reflection state indicating whether or not the data is reflected on each of the screen components; and a screen component managing unit which displays, on the display area, the screen components having the data reflected, and hides one or more screen components with reflection of the data incomplete.

Thus, the integrated circuit makes the user feel less uncomfortable.

### [Advantageous Effects of Invention]

A display area control apparatus, a display area control method, and an integrated circuit of the present invention can make a user feel less uncomfortable when it takes much time to display a screen component.

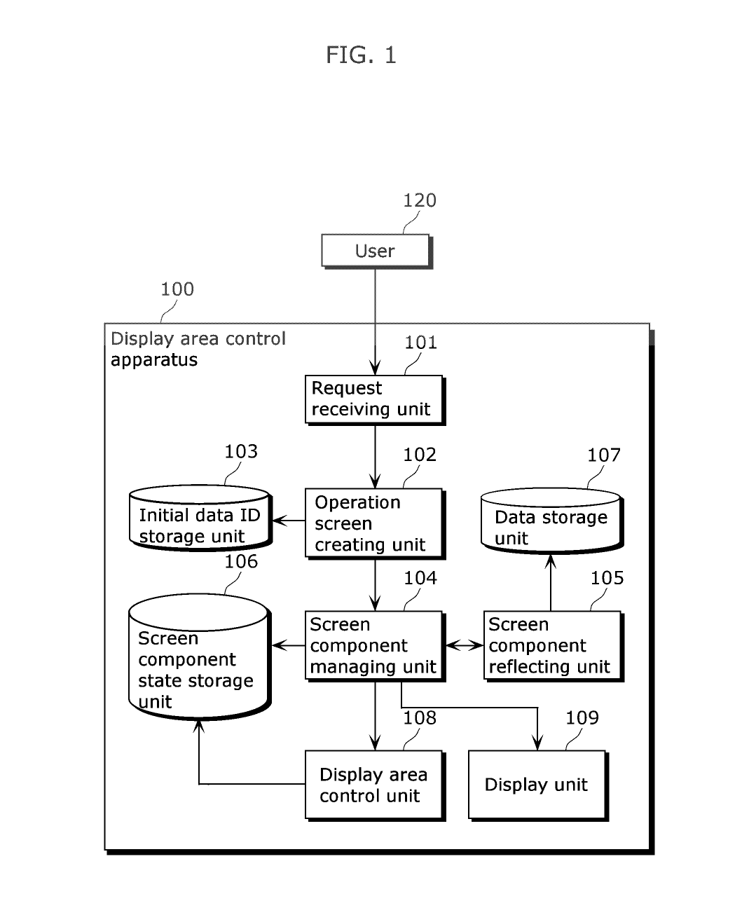

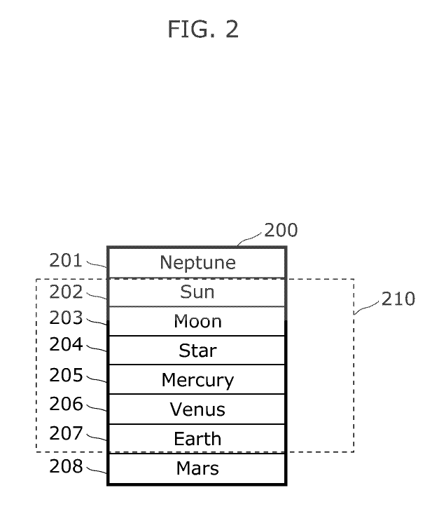

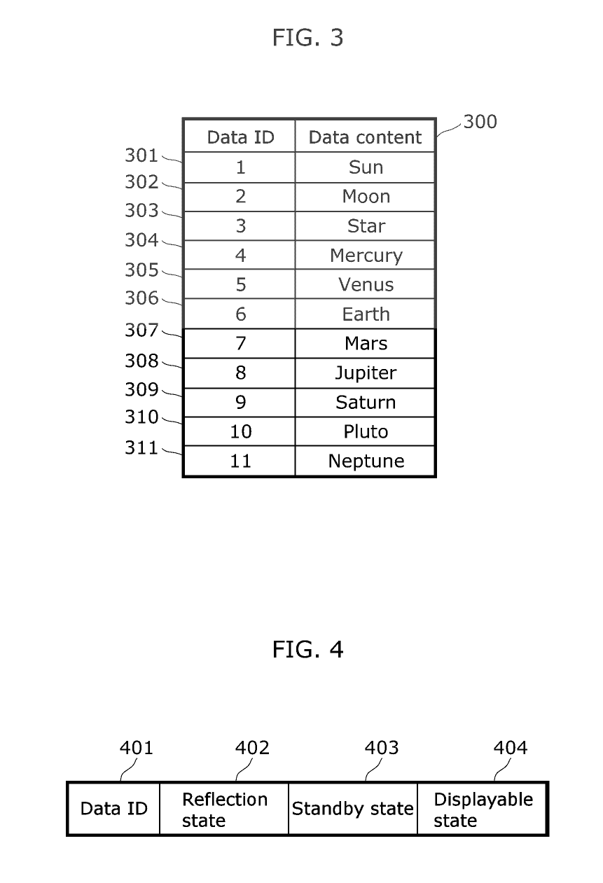

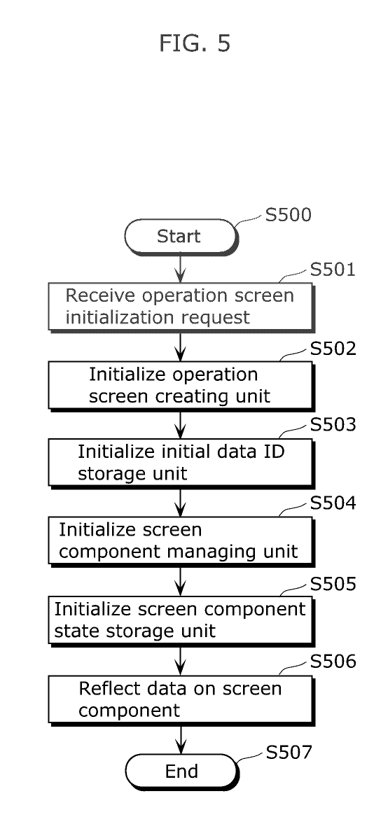

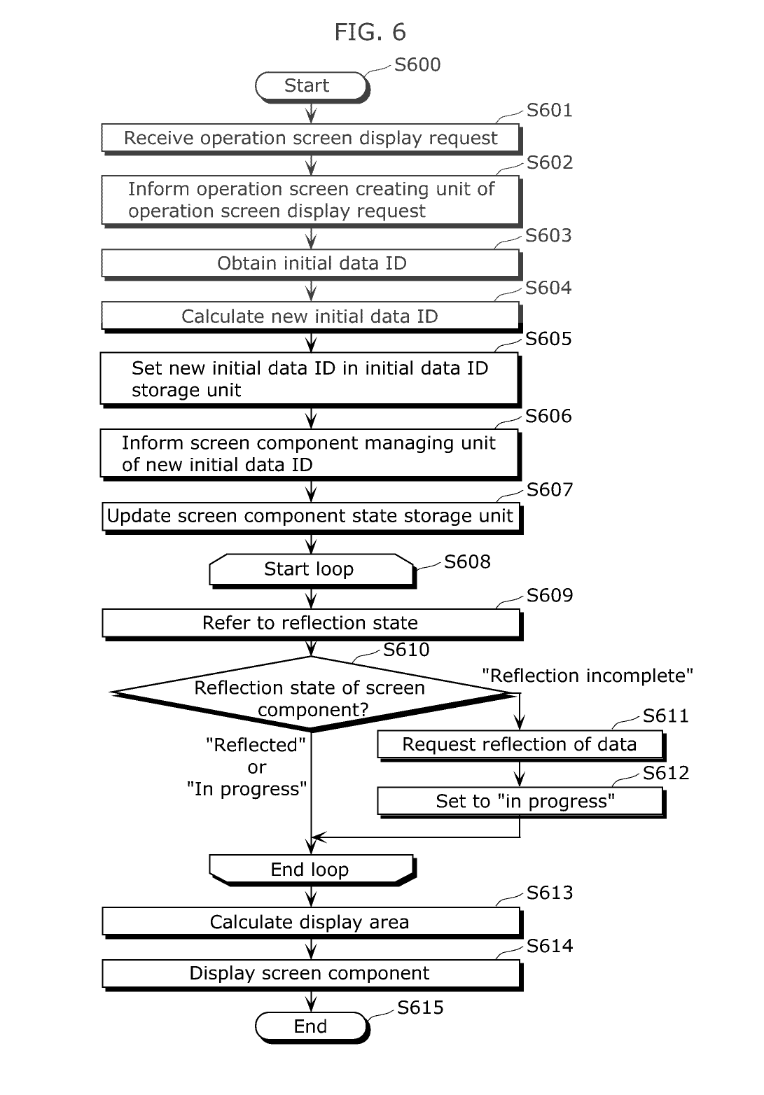

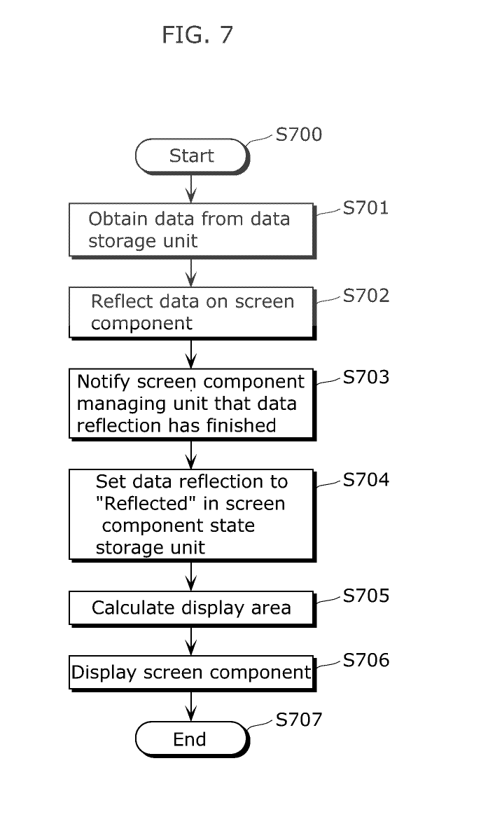

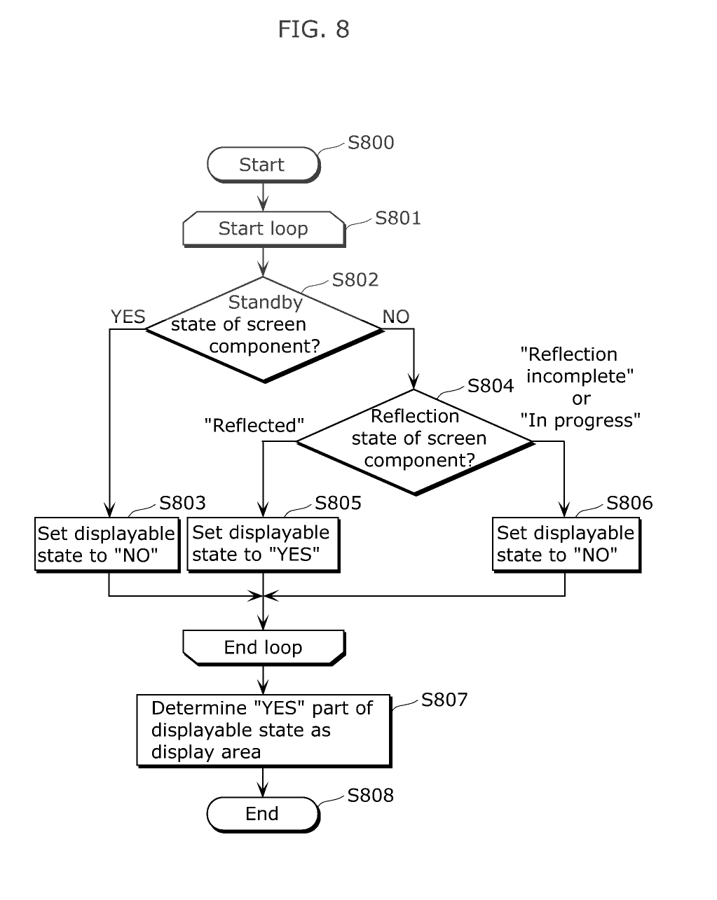

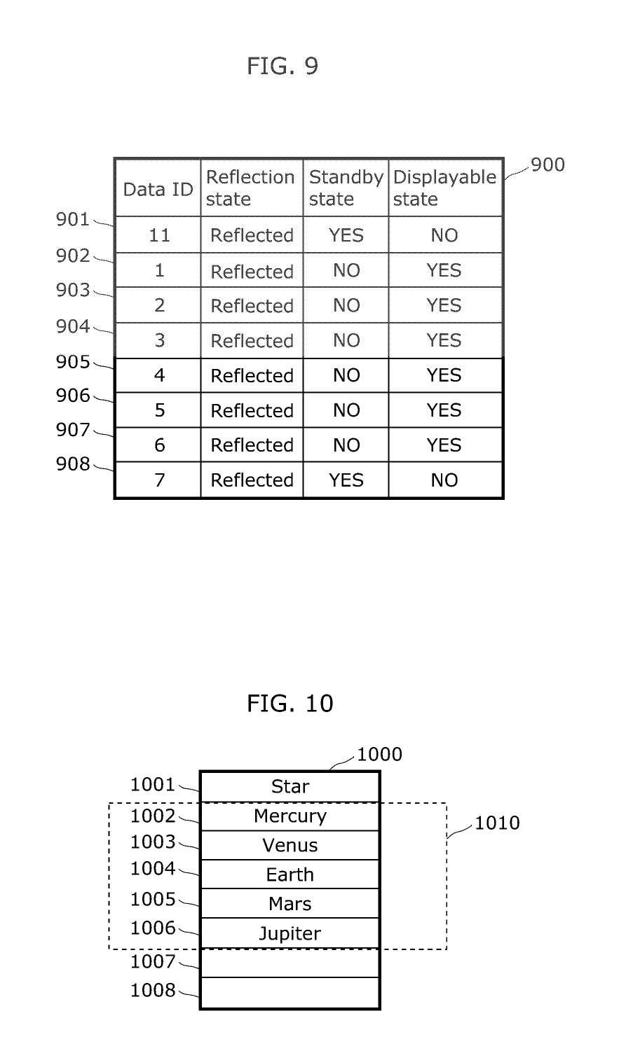

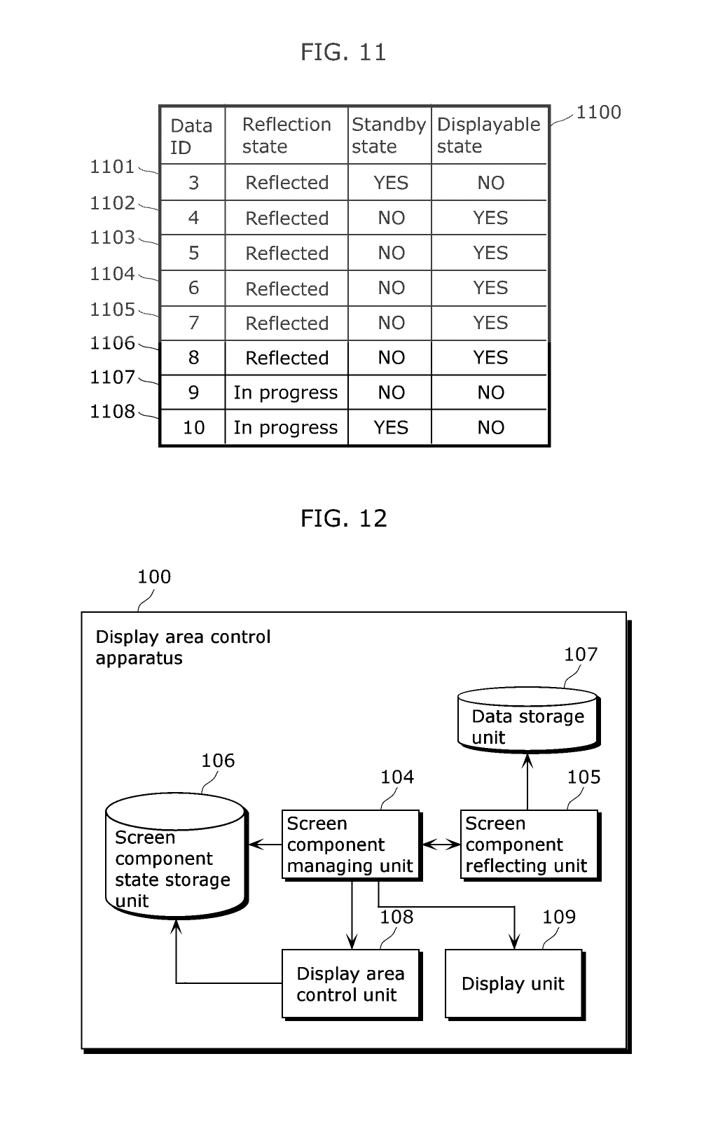

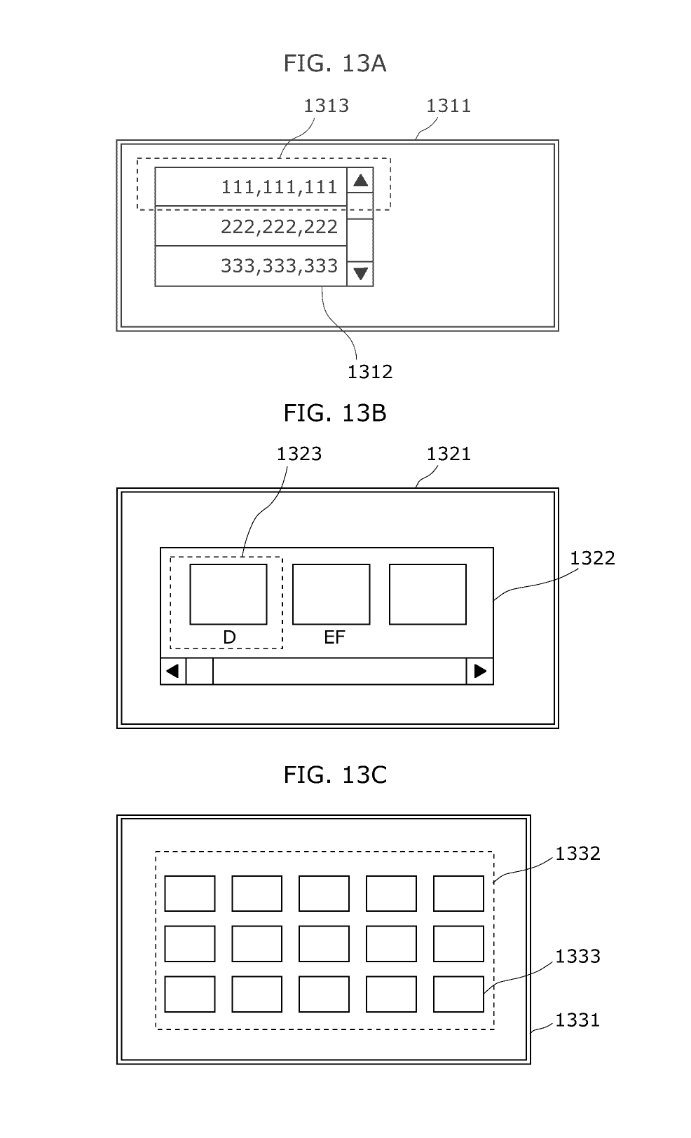

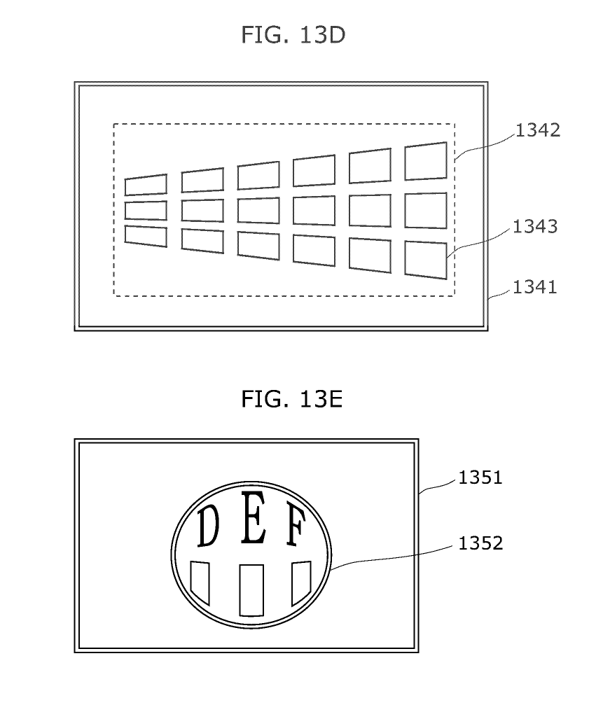

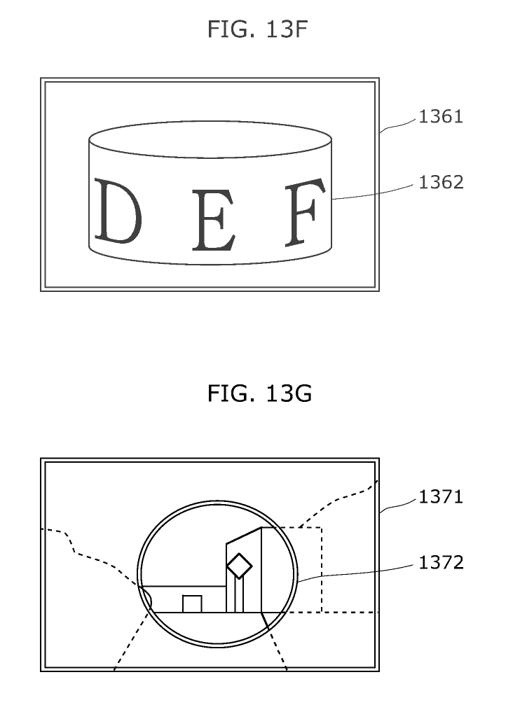

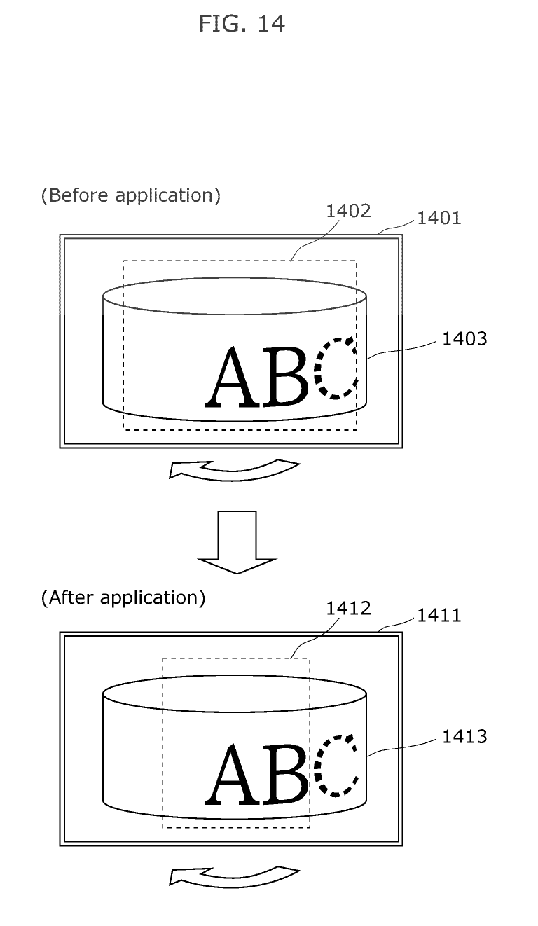

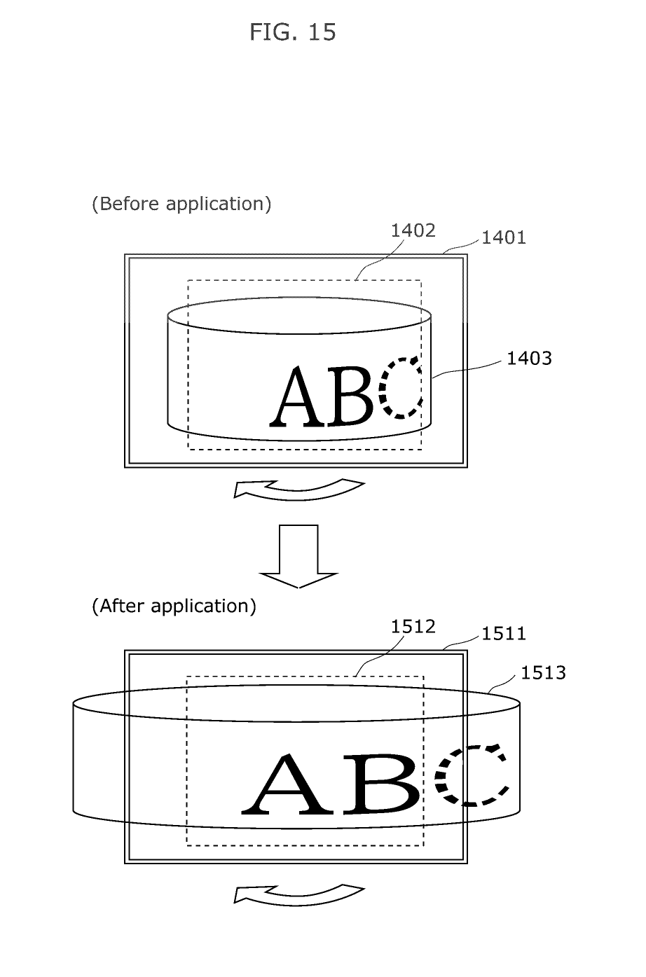

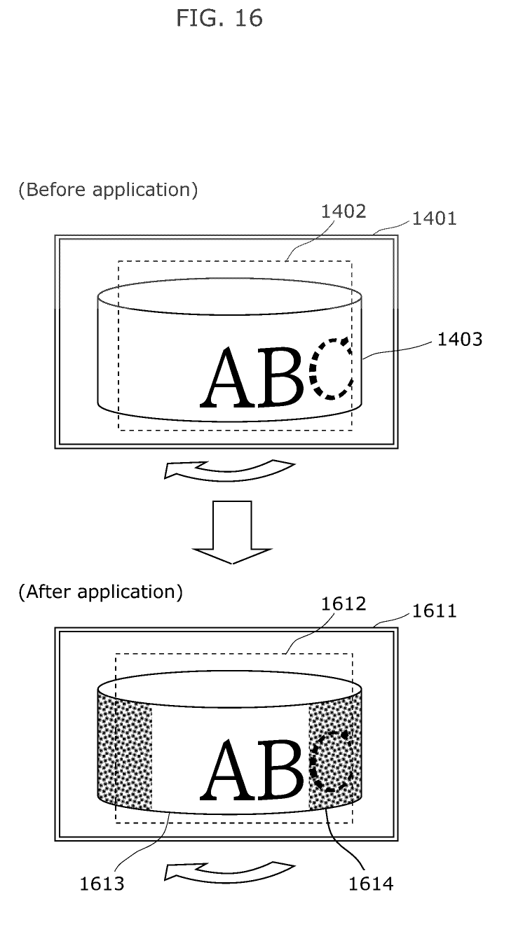

### BRIEF DESCRIPTION OF DRAWINGS

[FIG. 1] FIG. 1 shows a structure of a display area control apparatus according to an embodiment.

[FIG. 2] FIG. 2 exemplifies how the display area control apparatus according to an embodiment displays information.

[FIG. 3] FIG. 3 exemplifies data stored in a data storage unit according to the embodiment.

[FIG. 4] FIG. 4 exemplifies a kind of information stored in a screen component state storage unit according to the embodiment.

[FIG. 5] FIG. 5 depicts a flowchart showing how to carry out initialization operations according to the embodiment.

[FIG. 6] FIG. 6 depicts a flowchart showing how to display the operation screen according to the embodiment.

[FIG. 7] FIG. 7 depicts a flowchart after a data reflecting request is made to a screen component reflecting unit according to the embodiments.

[FIG. 8] FIG. 8 depicts a flowchart showing how a display area control unit according to the embodiment calculates a display area.

[FIG. 9] FIG. 9 lists information stored in the screen component state storage unit according to the embodiment.

[FIG. 10] FIG. 10 exemplifies how the display area control apparatus according to an embodiment displays information in scrolling.

[FIG. 11] FIG. 11 lists information stored in scrolling by the screen component state storage unit according to the embodiment.

[FIG. 12] FIG. 12 shows characteristic constituent features of the display area control apparatus according to the embodiment.

[FIG. 13A] FIG. 13A shows a first display example of a screen component according to the embodiment.

[FIG. 13B] FIG. 13B shows a second display example of the screen component according to the embodiment.

[FIG. 13C] FIG. 13C shows a third display example of the screen component according to the embodiment.

[FIG. 13D] FIG. 13D shows a fourth display example of the screen component according to the embodiment.

[FIG. 13E] FIG. 13E shows a fifth display example of the screen component according to the embodiment.

[FIG. 13F] FIG. 13F shows a sixth display example of the screen component according to the embodiment.

[FIG. 13G] FIG. 13G shows a seventh display example of the screen component according to the embodiment.

[FIG. 14] FIG. 14 shows a first example of hiding processing according to the embodiment. [FIG. 15] FIG. 15 shows a second example of the hiding processing according to the embodiment.

[FIG. 16] FIG. 16 shows a third example of the hiding processing according to the embodiment.

### DESCRIPTION OF EMBODIMENT

Described hereinafter is a display area control apparatus according to an embodiment of the present invention with reference to the drawings.

FIG. 1 shows a structure of the display area control apparatus according to the embodiment.

A display area control apparatus 100 in FIG. 1 includes a request receiving unit 101, an operation screen creating unit 102, an initial data ID storage unit 103, a screen component managing unit 104, a screen component reflecting unit 105, a screen component state storage unit 106, a data storage unit 107, a display area control unit 108, and a display unit 109.

The request receiving unit 101 receives a request from a user 120. The request from the user 120 includes an operation screen initializing request and an operation screen displaying request. Instead of the user 120, the actor to address the request to the request receiving unit 101 may be a computer program. The request is sent to the operation screen creating unit 102 via the request receiving unit 101.

Upon receiving the request from the request receiving unit 101, the operation screen creating unit 102 creates an operation screen.

The initial data ID storage unit 103 stores a data ID corresponding to the first screen component among screen components to be displayed on the operation screen. The data ID is an identifier for uniquely identifying a piece of data corresponding to a screen component. Based on the request from the user 120, the operation screen creating unit 102 calculates the data ID to be stored in the initial data ID storage unit 103.

The screen component managing unit 104 manages states of the screen components. The screen component which reflects the data corresponding to the data ID is displayed on the operation screen as an image, a character, and a moving image.

The screen component reflecting unit 105 obtains the data from the data storage unit 107, and reflects the obtained data on the screen component. This operation creates the screen component in a form of an image, a character, and a moving image.

The screen component managing unit 106 manages states of the screen components.

The data storage unit 107 stores the data corresponding to the data ID. The data to be stored includes an image, a character, and a moving image. The data to be stored may also include the size and the shape of the image, and the color of the character. Based on such data the screen component is created.

The display area control unit 108 calculates an area in which the screen component is displayed based on the state of the screen component stored in the screen component state storage unit 106.

The display unit 109 displays the screen component in the display area calculated by the display area control unit 108. The display unit 109 may display information, using visual effects taking advantage of animation and 3D graphics.

FIG. 2 exemplifies how the display area control apparatus 100 in FIG. 1 displays information.

A list 200 includes screen components 201 to 208; namely display elements, and is created by the operation screen creating unit 102. Each of the screen components 201 to 208 reflects a corresponding one of pieces of data. Each of the pieces of the data corresponds to one of data IDs. A display area 210 is an area which is actually displayed on the display unit 109. In other words, among the screen components 201 to 208 included in the list 200, the screen components 202 to 207 within the area of the display area 210 are displayed on the operation screen.

The screen components 201 and 208 are prepared for the user 120 scrolling the operation screen. If the screen components 201 and 208 were not prepared, the screen components 201 and 208 whose data reflection is incomplete thereon would be displayed in blank. Since the screen components 201 and 208 are prepared, the screen components 201 and 208 are immediately displayed in the display area 210 in the scrolling.

FIG. 3 exemplifies the data stored in the data storage unit 107 in FIG. 1.

A data storage table 300 in FIG. 3 holds the data to be stored in the data storage unit 107. The data storage table 300 associates, to store, (i) a data ID which uniquely identifies a piece of data with (ii) a piece of data content corresponding to the data ID. Rows 301 to 311 are information managed by the data storage table 300. The data ID is expressed in an index including a number, a string, and a hash value.

The data content is information showing a screen component. For example, the data content may be the screen component itself or may be information necessary to create the screen component. Furthermore, the data content may be information indicating the data or information which refers to the data entity. Two or more pieces of information may be managed as the data content.

FIG. 4 exemplifies a kind of information stored in the screen component state storage unit 106 in FIG. 1.

A data ID 401 corresponds to a piece of data to be reflected on a screen component by the screen component reflecting unit 105. A reflection state 402 is information indicating whether or not the screen component reflecting unit 105 reflects the piece of data, corresponding to the data ID, on the screen component. A standby state 403 is information indicating whether or not a screen component is prepared in a form of a standby screen component. In the scrolling, the standby screen component appears as the screen component. A displayable state 404 indicates whether or not a screen component is displayable in the display area 210.

FIG. 5 depicts a flowchart showing how the display area control apparatus 100 carries out initialization operations before displaying the operation screen.

First, the processing starts (S500). From the user 120, the request receiving unit 101 receives an operation screen initialization request for displaying the operation screen (S501). The operation screen initialization request is made before an operation screen display request.

Next, upon receiving the request, the request receiving unit 101 initializes the operation screen creating unit 102 (S502).

Then, the operation screen creating unit 102 initializes the initial data ID storage unit 103 (S503).

Then, the operation screen creating unit 102 initializes the screen component managing unit 104 (S504).

Then, the screen component managing unit 104 initializes the screen component state storage unit 106 (S505). Here, the reflection state 402 is set to “not reflected”. For each screen component, the standby state 403 is set to a state indicating whether or not the screen component is a standby. The displayable state 404 is set to “hide”.

Then, the screen component reflecting unit 105 reflects the data on the screen component necessary for displaying the operation screen (S506). These operations allows the display area control apparatus 100 to successfully display the operation screen without delay as soon as the display area control apparatus 100 receives the operation screen display request.

Then, the display area control apparatus 100 ends the processing (S507).

FIG. 6 depicts a flowchart showing how the display area control apparatus 100 in FIG. 1 displays the operation screen.

First, the processing starts (S600). The request receiving unit 101 receives, from the user 120, the operation screen display request for displaying the operation screen (S601). The operation screen display request includes a request which is made when the user 120 scrolls the operation screen. In other words, the operation screen display request includes a scroll request for displaying the operation screen through the scrolling.

Next, the request receiving unit 101 informs the operation screen creating unit 102 of the operation screen display request (S602). When the operation screen display request is made by the user 120 scrolling the operation screen, the operation screen display request includes information on the scrolling. The information on the scrolling is such as a scrolling direction, a scrolling amount, and scrolling acceleration.

Then, the operation screen creating unit 102 obtains an initial data ID from the initial data ID storage unit 103 (S603).

Next, the operation screen creating unit 102 calculates a new initial data ID from the information on the scrolling included in the operation screen display request and the initial data ID (S604). Thus, a screen component to be displayed is determined. It is noted that when no scroll-based operation screen display request is made, the new initial data ID is left as the initial data ID stored in the initial data ID storage unit 103.

Here, in the case where the screen component cannot be displayed in time since the acceleration and the scrolling amount included in the operation screen display request are excessively great, the operation screen creating unit 102 changes the acceleration and the scrolling amount to calculate the initial data ID. In such a case, the operation screen creating unit 102 refers to information stored in the screen component state storage unit 106 to calculate the initial data ID.

For example, the operation screen creating unit 102 refers to a reflection state stored in the screen component state storage unit 106 to determine a screen component to be displayed, so that a value indicating the number of screen components whose data reflection is incomplete is within a predetermined range. Then, the operation screen creating unit 102 calculates the new initial data ID. The value indicating the number of the screen components with data reflection incomplete is the number itself or the rate of such components. Thus, the operation screen creating unit 102 can reduce a chance of the screen component, with data reflection incomplete due to the scrolling, to be displayed.

Then, the operation screen creating unit 102 stores the new initial data ID in the initial data ID storage unit 103 (S605).

Next, the operation screen creating unit 102 informs the screen component managing unit 104 of the new initial data ID (S606).

Then, based on the new initial data ID, the screen component managing unit 104 updates information to be stored in the screen component state storage unit 106 (S607). For example, when the display area control apparatus 100 tries to display the list 200 shown in FIG. 2, the states of the screen components 201 to 208 are sequentially stored in the screen component state storage unit 106. In this example, the data ID corresponding to the screen component 202 is equal to the initial data ID.

It is noted that the information stored in the screen component state storage unit 106 is updated every time the user 120 operates the operation screen.

Furthermore, when the initial data ID is the starting data ID managed by the data storage unit 107, a data ID corresponding to the screen component 201 may be the ending data ID managed by the data storage unit 107. This allows the data managed by the data storage unit 107 to be repeatedly displayed as a screen component through scrolling. Here, the order and the technique managed by the data storage unit 107 may be other orders or techniques.

Next, the screen component managing unit 104 carries out processing on each of the states of the screen components stored in the screen component state storage unit 106 (S608).

Described next is the processing executed on the states of the screen components stored in the screen component state storage unit 106 (S608).

First, the screen component managing unit 104 refers to the reflection states of the screen components stored in the screen component state storage unit 106 (S609).

Here, when a reflection state of a screen component is “reflected” or “in progress”, the screen component managing unit 104 executes the processing on the state of the following screen component (S608).

Concurrently, when a reflection state of a screen component is “not reflected”, the screen component managing unit 104 requests the screen component reflecting unit 105 to reflect the data corresponding to the data ID on the screen component (S611). Next, the screen component managing unit 104 sets the state of the screen component to “in progress” in the screen component state storage unit 106 (S612). Then, the screen component managing unit 104 executes the processing on the state of the following screen component (S608).

After the end of the processing executed on the states of the screen components stored in the screen component state storage unit 106 ends (S608), the display area control unit 108 calculates the display area based on the information stored in the screen component state storage unit 106 (S613).

Next, the display unit 109 displays the screen components on the calculated display area (S614). Here, the screen component managing unit 104 displays, on the display area, a screen component with the data reflected, and hides a screen component with data reflection incomplete.

Then, the display area control apparatus 100 ends the processing (S615).

This processing makes it possible to hide the undisplayable screen component which takes too much time for the data reflection. Thus, in the case where a screen component takes so much time to be displayed, the display area control apparatus 100 can make the user feel less uncomfortable.

FIG. 7 depicts a flowchart of processing to be executed after the processing (S611) to request the reflection of the data in FIG. 6. The processing shown in FIG. 7 is executed in parallel with the processing from the step (S611) to request the reflection of the data in FIG. 6.

First, the processing starts (S700). The screen component reflecting unit 105, which is requested to reflect data, obtains the data corresponding to the data ID from the data storage unit 107 (S701).

After obtaining the data, the screen component reflecting unit 105 reflects the data on a screen component (S702). In some cases, the reflection of the data on the screen component does not end immediately.

After the reflection of the data, the screen component reflecting unit 105 notifies the screen component managing unit 104 that the data reflection has finished (S703).

Next, the screen component managing unit 104 sets the state of the screen component to “reflected” in the screen component state storage unit 106 (S704). In other words, the screen component managing unit 104 sets, to “reflected”, the reflection state of the screen component stored in the screen component state storage unit 106. Based on the information stored in the screen component state storage unit 106, the display area control unit 108 calculates the display area (S705).

Then, the display unit 109 displays the screen components on the calculated display area (S706). Here, the screen component managing unit 104 displays, on the display area, a screen component with the data reflected, and hides a screen component with data reflection incomplete.

Then, the display area control apparatus 100 ends the processing (S707).

It is noted that the processing (S705) in FIG. 7 for calculating the display area is similar to the processing (S613) in FIG. 6 for calculating the display area. Furthermore, the processing (S706) in FIG. 7 for displaying the screen components is similar to the processing (S614) in FIG. 6 for displaying the screen components. Once the data reflection on the screen component ends in the processing in FIG. 7, the display area control apparatus 100 calculates the display area and displays the screen component.

FIG. 8 depicts a flowchart showing the processing (S705) of calculating the display area shown in FIG. 7.

First, the processing starts (S800). The screen component managing unit 104 sets displayable state to each of the screen components stored in the screen component state storage unit 106.

Described next is the processing (S801) to set the displayable state to each of the screen components stored in the screen component state storage unit 106.

First, the screen component managing unit 104 checks the standby state of a screen component stored in the screen component state storage unit 106 (S802).

When the standby state is YES, the screen component managing unit 104 sets the displayable state to NO (S803). Then, the screen component managing unit 104 executes processing for setting the displayable state on the following screen component (S801).

When the standby state is NO, the screen component managing unit 104 checks the reflection state of the screen component (S804). Then, the reflection state is “reflected”, the displayable state is set to YES (S805). When the reflection state is “not reflected” or “in progress”, the displayable state is set to NO (S806). Then, the screen component managing unit 104 executes processing for setting the displayable state on the following screen component (S801).

The display area control unit 108 determines the screen components, whose displayable states are set to YES, as screen components to be displayed, and sets the display area so that the screen components fit in the area (S807).

Then, the display area control unit 108 ends the processing (S808).

This processing allows the display area control unit 108 to determine the display area used for displaying data-reflected screen components on the display unit, according to the reflection states of the screen components.

Described next is an operation of the display area control apparatus 100 with reference to FIGS. 2, 9, 10, and 11.

Assume that the list 200 in FIG. 2 is displayed in the range of the display area 210.

FIG. 9 lists information stored in the screen component state storage unit 106 when the list 200 in FIG. 2 is to be displayed. A row 900 is a kind of information to be stored in the screen component state storage unit 106. The states of rows 901 to 908 correspond to the states of the screen components 201 to 208 shown in FIG. 2.

The data has been reflected on the screen components 201 to 208. Thus, the reflection states of the rows 901 to 908 are “reflected”. The screen components 201 and 208, which respectively correspond to rows 901 and 908, have the data reflected to be ready to appear. Thus, the standby states of the screen components 201 and 208 are YES, and the standby states of the other screen components are NO.

The display area control unit 108 sets the displayable states of the rows 902 to 907 to YES, since these displayable states have the reflection states “reflected” and the standby states “NO”. The display area control unit 108 sets the other displayable states to NO. Here, an area to be designated as the display area is the areas corresponding to the rows 902 to 907. The displayable states of the rows 902 to 907 are set to YES by the display area control unit 108. In other words, the areas correspond to the screen components 202 to 207. Then, the screen components 202 to 207 are displayed on the display unit 109.

FIG. 10 exemplifies how the display area control apparatus 100 in FIG. 1 displays information in scrolling.

A list 1000 in FIG. 10 is to be displayed after the user 120 or the program makes a request to scroll down the list 200 in FIG. 2 to be displayed. The list 1000 includes screen components 1001 to 1008; namely display elements, and are created by the operation screen creating unit 102. Each of the screen components 1001 and 1008 has a corresponding one of pieces of data reflected. Each piece of the data corresponds to one of the data IDs.

Here, when the list 200 is scrolled faster than the data is reflected on the screen components 1007 and 1008, the reflection on the screen components 1007 and 1008 cannot be made in time. Thus, nothing is displayed in the areas where the screen components 1007 and 1008 are to be displayed. Here, the reflection states of the screen components 1007 and 1008 are “in progress”. The screen components 1007 and 1008 have not the data reflected yet. Thus, the display area control unit 108 reduces a display area 1010 to an area smaller than the display area 210 before the scrolling in FIG. 2.

The display area 1010 is an area actually displayed on the display unit 109. Among the screen components 1001 to 1008 included in the list 1000, the screen components 1002 to 1006 in the display area 1010 are displayed on the operation screen. The display area 1010 is enlarged to be as large as the display area 210 as soon as the reflection on the screen component 1007 ends.

Hence, the display area control apparatus 100 controls the display area to hide a screen component with data reflection incomplete.

FIG. 11 lists information stored in the screen component state storage unit 106 when the list 1000 in FIG. 10 is to be displayed. A row 1100 is a kind of information to be stored in the screen component state storage unit 106. The states of the rows 1101 to 1108 correspond to the state of screen components 1001 to 1008 in FIG. 10.

The data has been reflected on the screen components 1001 to 1006. Thus, the reflection states of the rows 1101 to 1106 are “reflected”. The screen components 1007 and 1008 are reflecting the data. Thus, the reflection states of the rows 1107 and 1108 are “in progress”.

The display area control unit 108 sets the displayable states of the rows 1102 to 1106 to “YES”, since these displayable states have the reflection states “reflected” and the standby states “NO”. The display area control unit 108 sets the other displayable states to “NO”. Here, an area to be designated as the display area is the areas corresponding to the rows 1102 to 1106. The displayable states of the rows 1102 to 1106 are set to “YES” by the display area control unit 108. In other words, the areas correspond to the screen components 1002 to 1006. Then, the screen components 1002 to 1006 are displayed on the display unit 109. Hence, the display area controlled by the display area control unit 108 is enlarged or reduced based on the states of the screen components to be displayed on the operation screen.

FIG. 12 shows characteristic constituent features of the display area control apparatus 100 according to the embodiment.

The display area control apparatus 100 in FIG. 12 includes the screen component managing unit 104, the screen component reflecting unit 105, the screen component state storage unit 106, the data storage unit 107, the display area control unit 108, and the display unit 109.

In other words, the request receiving unit 101, the operation screen creating unit 102, and the initial data ID storage unit 103 in FIG. 1 may be omitted. For example, the display area control apparatus 100 does not need a constituent features, such as the request receiving unit 101, in the case where the display area control apparatus 100 (i) sequentially displays the screen components at a predetermined time interval, and (ii) avoids receiving the operation of the user 120. The objects of the present invention may be achieved without the request receiving unit 101, the operation screen creating unit 102, and the initial data ID storage unit 103.

Moreover, the display area control of the present invention may be applicable to various screen images on a display, as well as to the list to be displayed on the operation screen. Shown hereinafter are examples of screen components to which the display area control is applied.

FIG. 13A shows a first display example of a screen component. A screen 1311 in FIG. 13A shows a screen component 1313 in a display area 1312. The display area 1312 has a vertical scroll bar. When a user scrolls the bar, screen components are sequentially displayed. More characters may be displayed as the screen components. In addition, images may be displayed as the screen components.

In such a case, the display area control apparatus 100 reduces the display area 1312 to hide a screen component with data reflection incomplete. The display area control apparatus 100 may change the scrolling amount to hide a screen component with data reflection incomplete.

FIG. 13B shows a second display example of a screen component. A screen 1321 in FIG. 13B shows a screen component 1323 in a display area 1322. The display area 1322 has a scroll bar. When a user scrolls the bar, screen components are sequentially displayed. Similar to the display example in FIG. 13A, the screen components may be displayed in more characters or in images.

Then, similar to the display example in FIG. 13A, the display area control apparatus 100 can hide a screen component with data reflection incomplete in the display example in FIG. 13B.

FIG. 13C shows a third display example of the screen component. A screen 1331 in FIG. 13C shows a screen component 1333 in a display area 1332. The screen component 1333 may be a character or an image. Furthermore, more screen components may be arranged.

In such a case, the display area control apparatus 100 reduces the display area 1332 to hide a screen component with data reflection incomplete. The display area control apparatus 100 may enlarge a screen component with the data reflected to hide a screen component with data reflection incomplete. In other words, when the screen component with the data reflected is displayed large, the screen component with data reflection incomplete does not fit in the display area. This operation hides the screen component with data reflection incomplete.

FIG. 13D shows a fourth display example of the screen component. A screen 1341 in FIG. 13D shows a screen component 1343 in a display area 1342. Similar to the display example in FIG. 13C, screen components are displayed in the display example in FIG. 13D. Furthermore, in the display example in FIG. 13D, the screen components are displayed with inclination. Thus, more screen components are displayed.

Then, similar to the display example in FIG. 13C, the display area control apparatus 100 can hide a screen component with data reflection incomplete in the display example in FIG. 13D. Moreover, the screen component managing unit 104 in the display area control apparatus 100 can change the number of the screen components to be displayed in the display area 1342 by changing the angle of the inclination. Thus, the screen component managing unit 104 can hide the screen component with data reflection incomplete by changing the angle of the inclination.

FIG. 13E shows a fifth display example of the screen component. A screen 1351 in FIG. 13E shows a screen component in a display area 1352. Each of the characters “D”, “E”, and “F”, is a screen component. The screen components are displayed on a spherical object. The area displayed in the spherical object is the display area 1352.

In such a case, the display area control apparatus 100 can increase or decrease the number of the screen components by changing the size of the spherical object. In other words, when there are fewer screen components with the data reflected, the display area control unit 108 in the display area control apparatus 100 reduces the display area 1352 shown in the spherical object. Hence, the display area control apparatus 100 hides the screen component with data reflection incomplete.

FIG. 13F shows a sixth display example of the screen component. A screen 1361 in FIG. 13F shows a screen component in a display area 1362. Each of the characters “D”, “E”, and “F”, is a screen component. The screen components are displayed on a cylindrical object. The area displayed in the cylindrical object is the display area 1362.

Then, similar to the display example in FIG. 13E, the display area control apparatus 100 can hide a screen component with data reflection incomplete by reducing the cylindrical object, when there are fewer screen components with the data reflected.

FIG. 13G shows a seventh display example of the screen component. A screen 1371 in FIG. 13G shows a screen component in a display area 1372. In other words, the only screen component to be displayed is one in the display area 1372 shown in a circle.

When there are fewer screen components with the data reflected in such a case, the display area control unit 108 in the display area control apparatus 100 reduces the display area 1372 shown in a circle. Hence, the display area control apparatus 100 can hide a screen component with data reflection incomplete.

The screen images shown in FIGS. 13A to 13G are examples. By enlarging or reducing the display area, the display area control apparatus 100 can hide screen components which are displayed in other manner with data reflection incomplete.

Described next are examples of screen component hiding processing.

FIG. 14 shows a first example of hiding processing according to the embodiment. FIG. 14 compares a screen 1401 before applying the hiding processing with a screen 1411 after applying the hiding processing.

A screen component is displayed in a display area 1402 of the screen 1401 before the application. Each of “A”, “B”, and “C” shown in FIG. 14 is a screen component. The screen components are displayed on a cylindrical object 1403. “A” and “B” are screen components with the data reflected. “C” is a screen component with data reflection incomplete. Thus, actually, “C” is not displayed.

Then, when the display area control apparatus 100 executes the hiding processing in the example shown in FIG. 14, the screen 1411 after the application is displayed. Similar to before the application, the screen components are displayed on a cylindrical object 1413. However, a display area 1412 of the screen 1411 is smaller than the area before application. Then, the screen component “C” with data reflection incomplete goes outside the display area 1412.

Thus, the screen component “C” with data reflection incomplete is hidden. Here, the area not to be displayed is not only the “C” part; moreover, the display area 1412 is reduced in total. This makes the user feel less uncomfortable.

FIG. 15 shows a second example of the hiding processing. FIG. 15 compares the screen 1401 before applying the hiding processing with a screen 1511 after applying the hiding processing.

The screen 1401 before the application is displayed in a similar manner as the example in FIG. 14.

Then, when the display area control apparatus 100 executes the hiding processing as shown in the example in FIG. 15, the screen 1511 after the application is displayed. The screen component managing unit 104 in the display area control apparatus 100 causes the display unit 109 to show a cylindrical object 1513 having screen components greater than the cylindrical object 1513 before the application. This operation enlarges the screen components, and the screen component “C” with data reflection incomplete goes outside a display area 1512.

Hence, the screen component “C” with data reflection incomplete is hidden. This makes the user feel less uncomfortable.

It is noted that the screen component managing unit 104 enlarges the screen components; instead, the screen component managing unit 104 may provide a greater space between the screen components. Hence, the screen component “C” with data reflection incomplete is hidden. This makes the user feel less uncomfortable.

FIG. 16 shows a third example of the hiding processing. FIG. 16 compares the screen 1401 before applying the hiding processing with a screen 1611 after applying the hiding processing.

The screen 1401 before the application is displayed in a similar manner as the example in FIG. 14.

Then, when the display area control apparatus 100 executes the hiding processing as shown in the example in FIG. 16, the screen 161 after the application is displayed. A display area 1612 and a cylindrical object 1613 after the application are the same as those before the application in size. Then, the screen component managing unit 104 in the display area control apparatus 100 provides gradations 1614 to both ends of an area within a display area 1612. This hides the screen component “C” with data reflection incomplete.

It is noted that the gradations 1614 may be colored dark in the vicinities of the boarders in the display area 1612, and colored light in the vicinity of the center of the display area 1612. This makes the user feel less uncomfortable.

The hiding processing has been described with reference to the drawings. When causing the display unit 109 to provide the display area controlled by the display area control unit 108, the screen component managing unit 104 may show an animated display area which is enlarging and reducing or may show the display area without animation. As shown in FIG. 16, the screen component managing unit 104 may shade the vicinity of the borders, and may enlarge and reduce the shading.

Moreover, when displaying the screen component on the display unit 109, the screen component managing unit 104 may control the transparency of the screen component to cause the screen component to fade in and fade out, so that the screen component with data reflection incomplete may be hidden. Furthermore, when displaying the screen component such that the screen component appears along with the surface of a 3D-cylinder or a 3D-sphere, the display area control apparatus 100 may change the display area by changing the diameter of the cylinder or the sphere, as well as by changing the display area. Preferably, the display area may change unnoticed by the user 120.

Moreover, the display area control unit 108 may increase or decrease the number of extra screen components to be prepared for smooth scrolling display of the operation screen. This operation allows the display area control apparatus 100 to reflect the data on the screen component when the display area control apparatus 100 has a lower processing load.

As described in the embodiment, the display area control apparatus of the present invention controls the display area used for displaying the screen component to hide a screen component with data reflection incomplete. This makes the user feel less uncomfortable when displaying the screen component takes much time.

Although only an exemplary embodiment of this invention has been described in detail above, those skilled in the art will readily appreciate that many modifications are possible in the exemplary embodiment without materially departing from the novel teachings and advantages of this invention. Accordingly, all such modifications are intended to be included within the scope of this invention.

A part or all of the constituent elements constituting the display area control apparatus in FIGS. 1 and 2 may be configured from a Large-Scale Integration (LSI). The constituent elements may be made as separate individual chips or as a single chip to include a part or all thereof. Furthermore, here, LSI is mentioned but there are instances where, due to a difference in the degree of integration, the designations IC, LSI, super LSI, and ultra LSI are used.

Furthermore, the means for circuit integration is not limited to an LSI, and implementation with a dedicated circuit or a general-purpose processor is also available. In addition, it is also acceptable to use a Field Programmable Gate Array (FPGA) that is programmable after the LSI has been manufactured, and a reconfigurable processor in which connections and settings of circuit cells within the LSI are reconfigurable.

Furthermore, if integrated circuit technology that replaces LSI appears thorough progress in semiconductor technology or other derived technology, that technology can naturally be used to carry out integration of the constituent elements.

Moreover, among the constituent elements in the display area control apparatus, the unit to store data alone may be separately configured without being formed in a single chip.

Instead of being provided as the display area control apparatus, the present invention may be provided as a method to include the processing units forming the display area control apparatus as steps. Then, the present invention may be provided as a program which causes a computer to execute the steps included in the method. Furthermore, the present invention may be provided as a computer-readable storage medium, such as a CD-ROM which stores the program.

### INDUSTRIAL APPLICABILITY

A display area control apparatus, a display area control method, and an integrated circuit of the present invention are effective in making a user feel less uncomfortable when displaying a screen component takes much time, and are useful for TVs, storage apparatuses, playback apparatuses, car navigation systems, cellular phones, fixed-line phones, printers, FAX machines, PDAs, PCs, digital cameras, refrigerators, microwaves, and washing machines.

### REFERENCE SIGNS LIST

100 Display area control apparatus
101 Request receiving unit
102 Operation screen creating unit
103 Initial data ID storage unit
104 Screen component managing unit
105 Screen component reflecting unit
106 Screen component state storage unit
107 Data storage unit
108 Display area control unit
109 Display unit
120 User
200 and 1000 List
201, 202, 203, 204, 205, 206, 207, 208, 1001, 1002, 1003, 1004, 1005, 1006, 1007, 1008, 1313, 1323, 1333, 1343 Screen component
210, 1010, 1312, 1322, 1332, 1342, 1352, 1362, 1372, 1402, 1412, 1512, 1612 Display area
300 Data storage table
301, 302, 303, 304, 305, 306, 307, 308, 309, 310, 311, 900, 901, 902, 903, 904, 905, 906, 907, 908, 1100, 1101, 1102, 1103, 1104, 1105, 1106, 1107, 1108 Row
401 Data ID
402 Reflection state
403 Standby state
404 Displayable state
1311, 1321, 1331, 1341, 1351, 1361, 1371, 1401, 1411, 1511, 1611 Screen
1403, 1413, 1513, 1613 Object
1614 Gradation

1. A display area control apparatus which displays one or more screen components that are display elements, said display area control apparatus comprising:
a display unit;
a data storage unit configured to store data for displaying the screen components;
a screen component reflecting unit configured to obtain the data stored in said data storage unit, and to reflect the obtained data on the screen components;
a screen component state storage unit configured to store a reflection state indicating whether or not the data is reflected on each of the screen components;
a display area control unit configured to determine, based on the reflection state, a display area for displaying, on said display unit, one or more screen components included in the screen components and having the data reflected; and
a screen component managing unit configured to display, on the display area, the screen components having the data reflected, and to hide one or more screen components with reflection of the data incomplete.

2. The display area control apparatus according to claim 1,
wherein said display area control unit is configured to determine the display area such that the screen components with the reflection of the data incomplete are excluded from the display area.

3. The display area control apparatus according to claim 1,
wherein said screen component managing unit is configured to hide the screen components with the reflection of the data incomplete by enlarging a size of the screen components having the data reflected.

4. The display area control apparatus according to claim 1,
wherein said screen component managing unit is configured to hide the screen components with the reflection of the data incomplete by providing a greater space between the screen components having the data reflected.

5. The display area control apparatus according to claim 1,
wherein said screen component managing unit is configured to hide the screen components with the reflection of the data incomplete by providing a gradation on the screen components with the reflection of the data incomplete.

6. The display area control apparatus according to claim 1, further comprising:
a request receiving unit configured to receive a scroll request for sequentially displaying the screen components; and
an operation screen creating unit configured to determine one or more screen components to be displayed according to the scroll request, the one or more screen components to be displayed being included in the screen components, wherein said display area control unit is configured to determine the display area according to a reflection state of the screen components to be displayed determined by said operation screen creating unit, and
among the screen components to be displayed determined by said operation screen creating unit, said screen component managing unit is configured to (i) display, on the display area, the screen components having the data reflected, and (ii) hide the screen components with the reflection of the data incomplete.

7. The display area control apparatus according to claim 6,
wherein, when determining the screen components to be displayed according to the scroll request, said operation screen creating unit is configured to determine the screen components to be displayed with reference to the reflection state such that a value indicating the number of the screen components with the reflection of the data incomplete is within a predetermined range.

8. The display area control apparatus according to claim 1,
wherein said screen component state storage unit further stores a standby state indicating whether or not a screen component included in the screen components is a standby screen component on which the data is to be reflected for display preparation, said display area control unit is configured to determine the display area according to the standby state such that the standby screen component is excluded from the display area, and
said screen component managing unit is configured to (i) display, on the display area, a screen component (a) included in the screen components, (b) not being the standby screen component, and (c) having the data reflected, and (ii) hide the screen component with the reflection of the data incomplete and the standby screen component.

9. A method for controlling a display area control apparatus which displays one or more screen components that are display elements, said method comprising:
obtaining data stored in a data storage unit, and reflecting the obtained data on the screen components, the data storage unit storing the data for displaying the screen components;
determining a display area for displaying, on a display unit, one or more screen components included in the screen components and having the data reflected, based on a reflection state stored in a screen component state storage unit, the reflection state indicating whether or not the data is reflected on each of the screen components; and
displaying on the display area the screen components having the data reflected, and to hide one or more screen components with reflection of the data incomplete.

10. An integrated circuit which is used for displaying one or more screen components that are display elements, said integrated circuit comprising:
a screen component reflecting unit configured to obtain data stored in a data storage unit, and to reflect the obtained data on the screen components, the data storage unit storing the data to be used for displaying the screen components;
a display area control unit configured to determine a display area for displaying, on a display unit, one or more screen components included in the screen components and having the data reflected, based on a reflection state stored in a screen component state storage unit, the reflection state indicating whether or not the data is reflected on each of the screen components; and
a screen component managing unit configured to display, on the display area, the screen components having the data reflected, and to hide one or more screen components with reflection of the data incomplete.
